(19) United States
(12) Patent Application Publication
(10) Pub. No.: US 2026/0178977 A1
(43) Pub. Date: Jun. 25, 2026

(54) RETRAINING APPARATUS, RETRAINING METHOD, AND A NON-TRANSITORY COMPUTER-READABLE MEDIUM

(71) Applicant: Hitachi, Ltd., Tokyo (JP)

(72) Inventor: Masaharu UKEDA, Tokyo (JP)

(21) Appl. No.: 19/424,318

(22) Filed: Dec. 18, 2025

(30) Foreign Application Priority Data
Dec. 20, 2024 (JP) 2024-225738

(51) Int. Cl. G06N 20/00

(52) U.S. Cl. CPC G06N 20/00

(57) ABSTRACT

A processor is configured to: upon performing inference using the learning model in response to an input, identify a specific group the data that has contributed to the output of the result of the inference by the learning model belongs to, calculate a contribution frequency of data belonging to the group to the output of the result of the inference performed using the learning model, and an accuracy change in the inference measured using test data created on the basis of the input and output data associated with the group, relative to the inference accuracy measured on the training data; select a retraining target group on the basis of the contribution frequency and the accuracy change of each of the groups; create retraining data on the basis of the input and output data belonging to the retraining target group according to the condition; and retrain the learning model.

### CROSS-REFERENCE TO RELATED APPLICATIONS

This application is based upon and claims the benefit of priority from Japanese Patent Application No. 2024-225738 filed in Japan Patent Office on Dec. 20, 2024, the contents of which are hereby incorporated by reference.

### BACKGROUND

The present disclosure relates to retraining of learning models.

Efforts to utilize large language models (LLMs) in business operations are being attempted by many companies. However, each company has its own unique business operations, and using a general-purpose LLM without any modification thereof may not always yield information with sufficient accuracy for the business operations. Therefore, there is a demand for LLMs tailored to respective business operations of each company.

In order to make LLMs suitable for business operations through fine-tuning based on supervised training data, it is necessary to perform cleansing and annotation on a large volume of data in the form of questions and answers (Q&A). As a result, it is not easy to prepare a sufficient and necessary amount of data.

As a method for retraining generative artificial intelligence models (generative AI models) such as LLMs, an approach is known in which retraining is performed using logs of questions posed to the generative AI models and answers obtained from the generative AI models, thereby continuously improving the generative AI models while the generative AI models are in operation. However, with this approach, it is difficult to determine an appropriate impetus to perform retraining.

In addition, generally, retraining generative AI models requires a large amount of graphics processing unit (GPU) resources; however, even if retraining is performed using a large amount of resources, sufficient accuracy may not necessarily be obtained any time depending on the quality of the training dataset.

WO 2022/113175 discloses a following approach: in a configuration where there exist two models that each perform inference, whether or not a tendency of data is changed in a case, where the inference accuracy based on the models is decreased, is determined, and in the case where determination is made that the tendency of the data is changed, priority is assigned to the models and retraining is performed.

### SUMMARY

However, in the approach disclosed in WO 2022/113175, it is necessary to analyze all data in order to determine whether or not to perform retraining, hence a problem arises in that the cost required for retraining increases due to the processing of this analysis.

An object included in the present disclosure is to provide a technique that enables retraining that efficiently improves the accuracy of a learning model.

An apparatus according to an aspect included in the present disclosure is a retraining apparatus for retraining a learning model, the retraining apparatus including:
a storage apparatus and a processor, wherein
the storage apparatus is configured to store training data which is partitioned into two or more groups on the basis of a predetermined condition, and a learning model that has been trained using the training data; and
the processor is configured to:
upon performing inference using the learning model in response to an input, identify a specific group the data that has contributed to an output of a result of the inference by the learning model belongs to, and associate the identified group with input and output data;
for each of the groups, calculate a contribution frequency, which is a frequency at which the data that belongs to the group that has contributed to the output of the result of the inference by the learning model, and calculates an accuracy change, which indicates a change in the inference accuracy measured using test data created on the basis of the input and output data associated with the group, relative to the inference accuracy measured on the training data;
select a retraining target group from the groups on the basis of the contribution frequency and the accuracy change of each of the groups;
create retraining data on the basis of the input and output data belonging to the retraining target group according to the condition; and
retrain the learning model on the basis of the retraining data.

A retraining method according to an aspect included in the present disclosure is a retraining method for retraining a learning model by an apparatus that includes a storage apparatus and a processor, the method including:
by the storage apparatus, storing training data which is partitioned into two or more groups on the basis of a predetermined condition, and a learning model that has been trained using the training data; and
by the processor:
upon performing inference using the learning model in response to an input, identifying a specific group the data that has contributed to an output of a result of the inference by the learning model belongs to, and associating the identified group with input and output data;
for each of the groups, calculating a contribution frequency, which is a frequency at which data that belongs to the group has contributed to the output of the result of the inference by the learning model, and an accuracy change, which indicates a change in the inference accuracy measured using test data created on the basis of the input and output data associated with the group, relative to the inference accuracy measured on the training data;
selecting a retraining target group from the groups on the basis of the contribution frequency and the accuracy change of each of the groups;
creating retraining data on the basis of the input and output data belonging to the retraining target group according to the condition; and
retraining the learning model on the basis of the retraining data.

A retraining program according to an aspect included in the present disclosure is a retraining program for retraining a learning model in an apparatus that includes a storage apparatus and a processor,
the storage apparatus being configured to store training data which is partitioned into two or more groups on the basis of a predetermined condition, and a learning model that has been trained using the training data,
the retraining program causing the processor to:
upon performing inference using the learning model in response to an input, identify a specific group the data that has contributed to an output of a result of the inference by the learning model belongs to, and associate the identified group with input and output data;
for each of the groups, calculate a contribution frequency, which is a frequency at which data that belongs to the group has contributed to the output of the result of the inference by the learning model, and an accuracy change, which indicates a change in the inference accuracy measured using test data created on the basis of the input and output data associated with the group, relative to the inference accuracy measured on the training data;
select a retraining target group from the groups on the basis of the contribution frequency and the accuracy change of each of the groups;
create retraining data on the basis of the input and output data belonging to the retraining target group according to the condition; and
retrain the learning model on the basis of the retraining data.

According to an aspect included in the present disclosure, it becomes possible to perform retraining that efficiently improves the accuracy of a learning model.

### BRIEF DESCRIPTION OF THE DRAWINGS

FIG. 1 is a conceptual diagram showing a configuration example of an AI system according to an embodiment of the present disclosure;

FIG. 2 is a conceptual diagram showing an example of processing performed by a data preparation apparatus according to an embodiment of the present disclosure;

FIG. 3 is a conceptual diagram showing an example of processing performed by an inference apparatus according to an embodiment of the present invention;

FIG. 4 is a conceptual diagram showing an example of processing performed by a retraining apparatus according to an embodiment of the present disclosure;

FIG. 5 is a flowchart showing processing performed by a data partitioning unit according to an embodiment of the present disclosure;

FIG. 6 is a flowchart showing processing performed by a data selection unit according to an embodiment of the present disclosure;

FIG. 7 is a flowchart showing processing performed by a data reclassification unit according to an embodiment of the present disclosure;

FIG. 8 is a conceptual diagram showing a configuration example of a learning model according to an embodiment of the present disclosure; and

FIG. 9 is a block diagram showing an example of the hardware configuration of various apparatuses or systems according to an embodiment of the present disclosure.

### DETAILED DESCRIPTION OF THE EMBODIMENT

Hereinafter, embodiments of the present invention will be described with reference to the drawings.

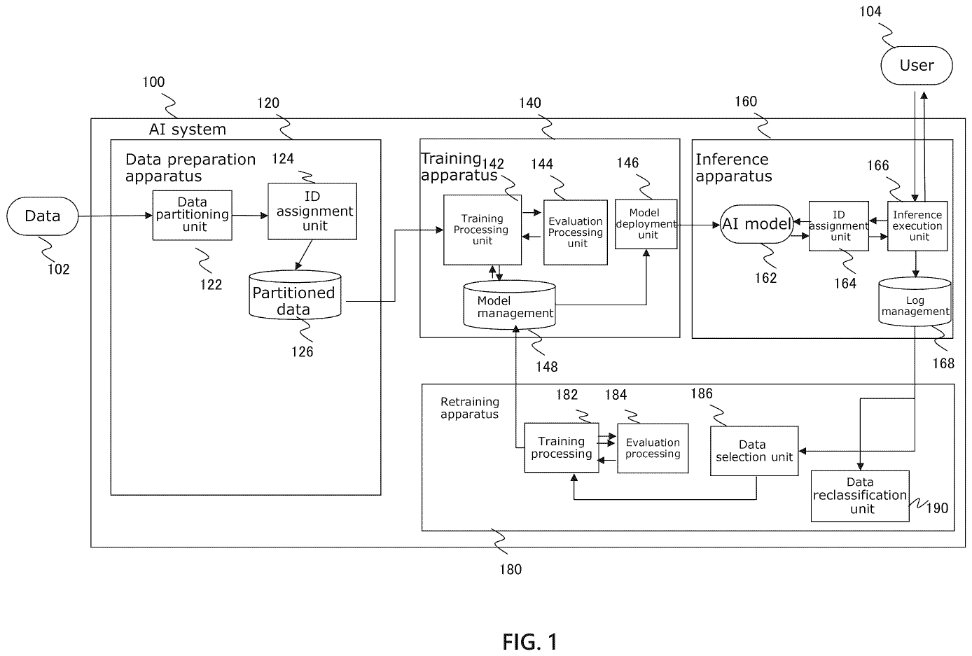

FIG. 1 is a conceptual diagram showing a configuration example of an AI system according to an embodiment of the present disclosure.

An AI system 100 includes a data preparation apparatus 120, a training apparatus 140, an inference apparatus 160 and a retraining apparatus 180.

The data preparation apparatus 120 includes a data partitioning unit 122, an ID assignment unit 124, and a storage apparatus 126. The data partitioning unit 122 has a function of partitioning data 102 that is input. The data 102 includes text such as design specification documents, manuals, procedure manuals and conversation histories; structured text such as JSON (JavaScript Object Notation) and HTML (Hyper Text Markup Language); and data that can be textualized, such as character information extracted from images and audio, and transcriptions. The data partitioning performed by the data partitioning unit 122 may partition data on the basis of the similarity of documents, the similarity of answers, the version of documents, or the like. Such data partitioning may include not only mechanical partitioning based on information regarding the data structure possessed by the data 102, for example, data related to configurations such as punctuation marks, paragraphs, chapters, pages, tables, and bulleted lists, but also partitioning considering the contextual semantic connections that can be estimated from semantic proximity based on the type of words contained in a certain block of text, and prefixes or the like. The data partitioning processing performed here may be individual partitioning according to two or more different rules. In addition, the partitioning here does not mean only physical data partitioning; it may also be performed in a form that stores addresses indicating data boundaries, such as file names, character counts, paragraphs, byte positions, etc. In this way, data can be logically partitioned at various boundaries. Here, configurations such as punctuation marks, paragraphs, chapters, pages, tables, and bulleted lists, and semantic proximity constitute partitioning rules 216. However, the partitioning based on the aforementioned punctuation marks, etc., has clear boundary conditions, but there may be cases where the boundary conditions are not clear, such as in the case of semantic proximity. Therefore, in the present disclosure, the criterion for determining to which data group a certain data belongs—whether it is contained in a certain data group or is close to two or more data groups—is referred to as a scoring pattern. Examples of this scoring pattern include a pattern that uses a certain character string as a boundary condition, and a pattern in which the vector distance between information obtained by converting the data into a multi-dimensional vector and the multi-dimensional vector at the center of a certain data group or the multi-dimensional vector of data in the boundary region of the data group is calculated, and the data is considered to belong to the nearest data group. The ID assignment unit 124 has a function of assigning an ID to the data partitioned by the data partitioning unit 122. As described above, in the case where the data is partitioned according to two or more different rules, the ID may be managed to include both an ID indicating the partitioning pattern and an ID indicating the data physically or logically partitioned within that pattern. The partitioned data to which the ID is assigned is stored in the storage apparatus 126.

The training apparatus 140 includes a training processing unit 142, an evaluation processing unit 144, a model deployment unit 146, and a storage apparatus 148. The training processing unit 142 has a function of performing training processing by using the partitioned data acquired from the data preparation apparatus 120. Here, the training processing is processing such as machine learning, deep learning, and large language models, which patterns the features of input data to enable recognition, classification, conversion, and inference, and is defined by programs or data. The model generated through the training processing has the features of generating, as an output, on the basis of the characteristics of the data it was trained on, the results of recognition, classification, conversion, and inference for an input that does not depart from the range of the trained data. The evaluation processing unit 144 has a function of evaluating a result of training performed by the training processing unit 142. The evaluation of a result of training here is processing for verifying whether the model has the features of the input data used in training. This includes processing such as calculating, by verifying whether correct answer data or output that can be regarded as correct answer data is obtained when the evaluation data is processed by the model, by using evaluation data similar to the input data and correct answer data related to the results of recognition, classification, conversion, and inference, the proportion at which correct answer data or an output that can be regarded as correct answer data is obtained, as well as analyzing the features of the input data for which correct answer data or an output that can be regarded as correct answer data could not be obtained. The model deployment unit 146 has a function of deploying a model that has received favorable evaluations from the evaluation processing unit 144. Here, deployment refers to the processing of deploying a model stored as data or a file on a computer in an executable state, making it accessible and processable. This includes the deployment of an application on an operating system (OS) and the deployment of a container in a container environment. The storage apparatus 148 has a function of storing models and other necessary data. Specific examples of the storage apparatus 148 include a database server, a file server, and a database service or file storage service on the cloud. In the storage apparatus 148, models obtained through training performed by the training processing unit 142 and models acquired from a retraining apparatus 180 described later are accumulated. Models accumulated in the storage apparatus 148 are loaded into the training processing unit 142 when model training is performed. The models accumulated in the storage apparatus 148 are transferred to the model deployment unit 146 when the models are used.

The inference apparatus 160 includes an AI model 162, an ID assignment unit 164, an inference execution unit 166, and a storage apparatus 168. The AI model 162 is a model deployed to the inference apparatus 160 by the model deployment unit 146. The ID assignment unit 164 has a function of assigning an ID to the input and output data of the AI model 162. Here, the ID assigned to the input and output data of the AI model 162 is a unique ID allocated in response to a processing request from a user or a system, and this ID is stored in association with the ID of the user or system that made the processing request. Furthermore, the processing request may also be stored in association with various pieces of call processing performed in AI Model 162. Specific examples of this ID include an ID for identifying a processing request to another AI model when the AI model 162 is partitioned into a plurality of AI models and a plurality of calls are made between the AI models in response to a single processing request, and an ID for identifying a processing request in the case where there is an application at the front end of the AI model 162 that aggregates processing requests to the AI model 162, or in the case where a processing request is made from these applications to another application or system. The inference execution unit 166 has a function of performing inference using the input and output data of the AI model 162 on the basis of an instruction from a user 104. Here, the inference processing is processing of processing input data by a model to perform recognition, classification, conversion, and inference. This includes, for example, processing such as Y=AX, where Y is the output, X is the input, and A is the model. The storage apparatus 168 stores log data of the executed inference processing. Here, the log data may include, in addition to an ID indicating the user or system performing the main processing, input data, an ID indicating the input data, output data, and an ID indicating the output data, intermediate states when the input and output data are processed by the AI model 162, communication logs with other AI models or applications in the case where the AI model 162 is composed of a plurality of models and applications, an ID indicating the communication logs, and a relationship between the communication ID and the ID indicating the input and output data or the ID indicating the user or system performing the main processing.

The retraining apparatus 180 retrains a learning model. The retraining apparatus 180 includes a storage apparatus and a processor. The storage apparatus is configured to store training data which is partitioned into two or more groups on the basis of a predetermined condition, and a learning model that has been trained using the training data. The processor is configured to: upon performing inference using the learning model in response to an input, identify a specific group the data has contributed to the output of the result of the inference y the learning model belongs to and associate the identified group with input and output data. The retraining apparatus 180 calculates, for each of the groups, a contribution frequency, which is the frequency at which data belonging to the group contributes to the output of the result of the inference performed using the learning model, and an accuracy change, which indicates a change in the inference accuracy measured using test data created on the basis of the input and output data associated with the group, relative to the inference accuracy measured on the training data. An example of this processing is as follows: for a trained base model, in the present embodiment, data is partitioned into a plurality of groups on the basis of features, and training is performed for each partitioned group. In this training, a method is used wherein training is performed as an additional sub-module without altering the parameters of the base model itself, and the results of the base model and the sub-module are combined at the output stage, thereby reflecting the additional training part. This generally includes a method called adapter tuning. At this time, since the training data is associated with the additional training part, by including part of the information of a data source serving as the basis for an output result of a model, it is possible to estimate which dataset has contributed to the output. In this way, by repeatedly providing inputs to the model and obtaining outputs from the model, and taking statistics on the relationship between the inputs and outputs and the data contributing to the outputs, it is possible to calculate which data has contributed the most to the generation of the output in a use case where this model is used. This statistical data indicates the contribution frequency. Next, in the test phase, in the case where a dataset for test is generated on the basis of assumed use cases, and test is conducted, the result of the test using this test data can show, for each additional training part, on the basis of the relationship between the training data and the additional training part, whether an output with correct answers is obtained for the test data. In other words, the inference accuracy is derived for each additional training part. However, in actual use cases, inputs and outputs different from those in the test may also occur. Therefore, the inference accuracy of each additional training part changes during the evaluation of logs in actual use cases. For this reason, by comparing the correct answer data of the test for each of the certain additional training parts that is included in the test data, with the tendency of an output to which the certain additional training part contributes significantly, it is possible to determine whether the output is close to the correct answer or not. However, this processing may allow a person to determine the log and determine whether it is correct, or it may use a separate LLM or program for accuracy evaluation to make the determination. The change in the inference accuracy of each additional training part per certain time unit, calculated as a result of this, is the accuracy change. The retraining apparatus 180 selects a retraining target group from the groups on the basis of the contribution frequency and the accuracy change of each of the groups. This selection is performed by the data selection unit 186. The retraining apparatus 180 creates retraining data on the basis of the input and output data belonging to the retraining target group according to a data condition. The retraining data may be a combination of questions and answers. However, in many cases, since questions are in a state lacking sufficient information, the AI model 162 and applications used in combination with the AI model 162 may convert the questions into a state containing information necessary for answers before executing inference. For example, in the case where there is an inquiry about an error message and a solution strategy at a support window, and an answer is to be created by the AI model 162 for this, information such as the product name, the conditions for generating the error message, the manual describing the error message, and the product specifications, which are insufficient in the question, is required. A combination of questions and answers that includes the required information, with these necessary pieces of the information supplemented, may be used as training data. In addition, for cases where the model fails to answer correctly for frequently occurring inputs and outputs, a correct answer to the question may be newly created and used as training data. This processing may be the processing of instructing a person to generate an answer to the question and incorporating the result. The creation of this retraining data is performed by the data selection unit 186. A training processing unit 182 retrains the learning model on the basis of retraining data. The retrained learning model is stored in the storage apparatus 148 of the training apparatus 140.

The retraining apparatus 180 includes the training processing unit 182, an evaluation processing unit 184, the data selection unit 186, and a data reclassification unit 190. The processor, by executing a program stored in the storage apparatus, functionally implements the training processing unit 182, the evaluation processing unit 184, the data selection unit 186, and the data reclassification unit 190.

The training processing unit 182 has a function of performing training processing by using the training data selected by the data selection unit 186. The evaluation processing unit 184 has a function of evaluating a result of training performed by the training processing unit 182. The data selection unit 186 has a function of selecting a retraining target group from the groups on the basis of the contribution frequency and the accuracy change of each of the groups. In addition, the data selection unit 186 has a function of creating retraining data on the basis of the input and output data belonging to the retraining target group according to a data condition. The data reclassification unit 190 has a function of, in the case where two or more input groups with different features exist within the inputs of the input and output data associated with a group, partitioning the group into two or more groups for each of the features.

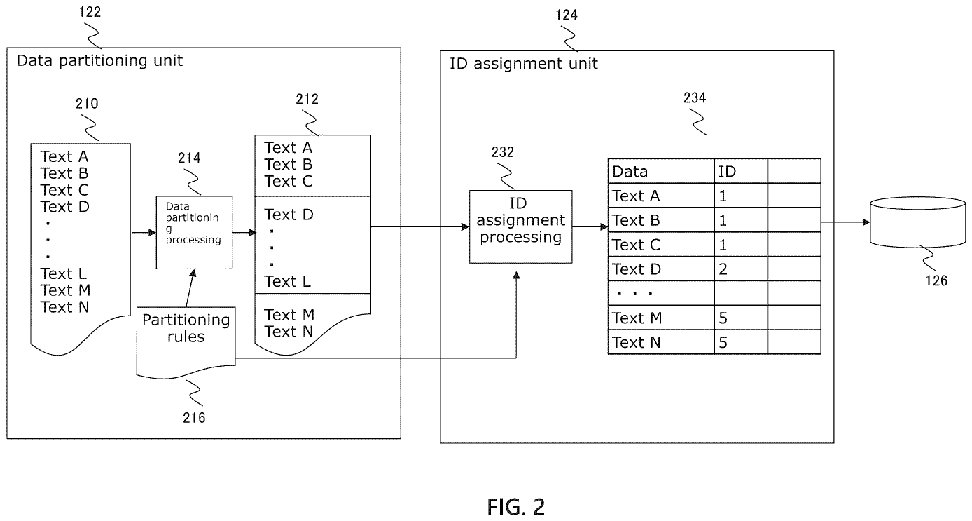

FIG. 2 is a conceptual diagram showing an example of processing performed by a data preparation apparatus according to an embodiment of the present disclosure.

The data partitioning unit 122 performs data partitioning processing 214 on data 210 on the basis of the data 102 to generate partitioned data 212. The partitioning algorithm used at this time is based on the partitioning rules 216, which are information defining predetermined rules.

The ID assignment unit 124 performs ID assignment processing 232 on the partitioned data 212 to generate ID-assigned partitioned data 234. In this example, the value “1” is assigned as an ID to Text A through Text C included in the first group within the partitioned data 212. Similarly, the value “2” is assigned as an ID to Text D through Text L included in the second group. Thereafter, in the same manner, an ID for each group formed through partitioning is assigned to each corresponding portion of the partitioned data 212. Note that the ID assignment processing 232 may perform the aforementioned ID assignment processing with reference to the information of the partitioning rules 216. The ID-assigned partitioned data 234 is stored in the storage apparatus 126.

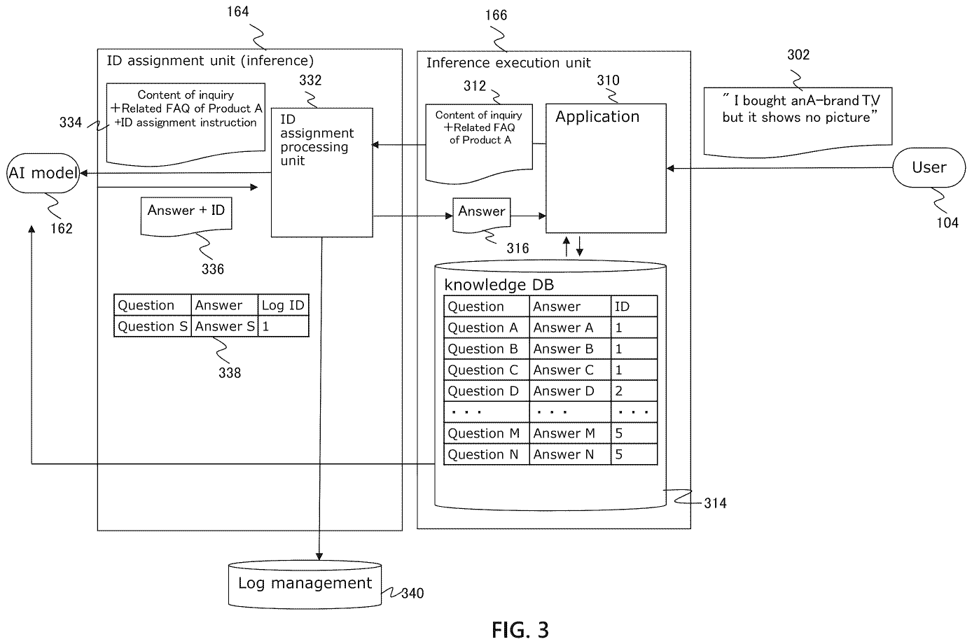

FIG. 3 is a conceptual diagram showing an example of processing performed by an inference apparatus according to an embodiment of the present invention.

The user 104 inputs a question 302 via a terminal apparatus or the like possessed by the user. In this example, the question 302 is “I bought an A-brand TV, but it shows no picture.”

An application 310 installed in the inference execution unit 166 acquires information of the question 302. The application 310 sends, to an ID assignment processing unit 332, data 312 formed by adding the related FAQ information of Product A to the question 302 (i.e., the content of the inquiry).

The ID assignment processing unit 332 performs ID assignment processing by using, for example, the AI model 162. The ID assignment processing unit 332 inputs, to the AI model 162, data formed by further adding an ID assignment instruction to the content of the inquiry and the related FAQ information of Product A. Then, data 336 including an answer and an assigned ID is output from the AI model 162. On the basis of this data 336, the ID assignment processing unit 332 generates log data 338 and stores the log data in the storage apparatus 340. The log data 338 includes, as information items, questions, answers, and the assigned IDs.

The set of questions, answers, and IDs may be accumulated as a knowledge DB in the storage apparatus 314 on the inference execution unit 166 side. This knowledge DB constitutes the above-mentioned related FAQ information. The application 310 may acquire an answer 316 and output the answer 316 to the user, but since the above-mentioned ID is unnecessary information for the user, the ID may not be included in the output data to the user. Note that the storage apparatus 314 may be the storage apparatus 168 shown in FIG. 1. The data accumulated in the storage apparatus 314 may be transmitted to the storage apparatus 168 shown in FIG. 1.

As described above, an instruction to add identification information indicating a specific group the data has contributed to the output of the result of the inference belongs to, to the output is added to the user input provided by a user, and the result is input to the learning model. A specific group the data has contributed to the output of the result of the inference belongs to, is identified from the identification information output from the learning model, and the user output obtained by removing the identification information from the output of the learning model is presented to the user. The user input here corresponds to the question 302 in the figure. The identification information indicating a specific group the data has contributed to the output of the result of the inference belongs to, corresponds to the ID. The learning model corresponds to the AI model.

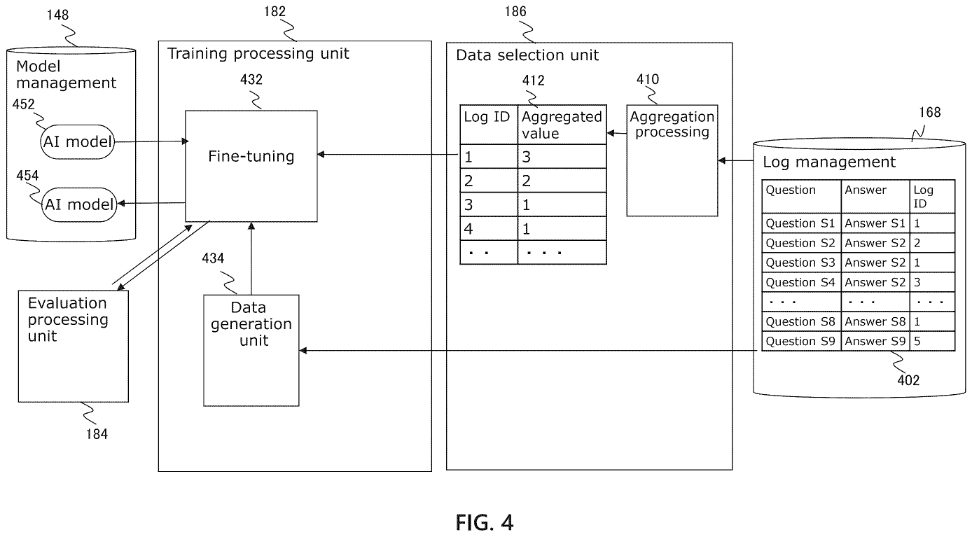

FIG. 4 is a conceptual diagram showing an example of processing performed by a retraining apparatus according to an embodiment of the present disclosure.

The storage apparatus 168 stores a set 402 of questions, answers, and log IDs. The data selection unit 186 performs aggregation processing 410 to aggregate the set 402 by log ID. An aggregation result 412 includes the aggregated value for each log ID. For example, in the case where the set 402 includes three pieces of data with a log ID of 1, the aggregated value for log ID=1 is 3.

The data selection unit 186 selects, on the basis of the aggregated values of the aggregation result 412, data to be used for fine-tuning 432. For example, fine-tuning 432 may be performed on the basis of data with an aggregated value of 2 or more.

A data generation unit 434 generates data to be used for fine-tuning 432 on the basis of the data accumulated in the set 402.

Fine-tuning 432 is performed on an AI model 452 stored in the storage apparatus 148 to obtain a tuned AI model 454. This fine-tuning 432 is performed by performing evaluation processing on the output data obtained by inputting the data used for fine-tuning into the AI model.

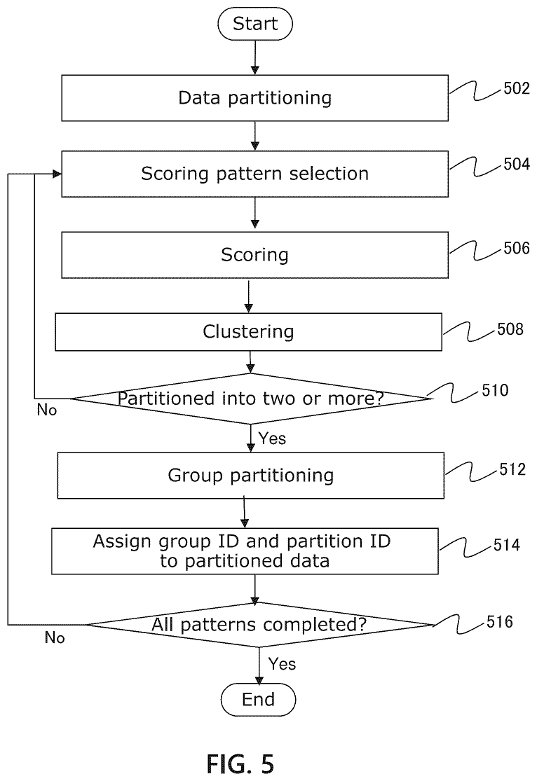

FIG. 5 is a flowchart showing processing performed by a data partitioning unit according to an embodiment of the present disclosure.

The data partitioning unit 122 performs data partitioning (step 502). The data partitioning unit 122 selects a scoring pattern (step 504). The scoring pattern refers to the criterion used by the data partitioning unit 122 to partition data on the basis of the partitioning rules 216. Since the data partitioning unit 122 can logically or physically differentiate data according to a plurality of scoring patterns, two or more scoring patterns can be configured. The current step corresponds to the processing of selecting one of these patterns.

The data partitioning unit 122 performs scoring on the data on the basis of the selected scoring pattern (step 506). Next, the data partitioning unit 122 performs clustering (step 508).

The data partitioning unit 122 determines whether the data is partitioned into two or more groups as a result of the clustering (step 510). If it is determined that the data is partitioned into two or more groups, the processing proceeds to step 512. If it is determined that the data is not partitioned into two or more groups, the processing returns to step 504.

In step 512, the data partitioning unit 122 partitions the data into two or more groups. Then, a group ID and a partition ID are assigned to the partitioned data (step 514).

The data partitioning unit 122 determines whether the processing has been completed for all scoring patterns (step 516). If processing for all scoring patterns has been completed, the processing shown in FIG. 5 ends. If processing for all scoring patterns has not been completed, the processing returns to step 504 to perform selection of the next scoring pattern.

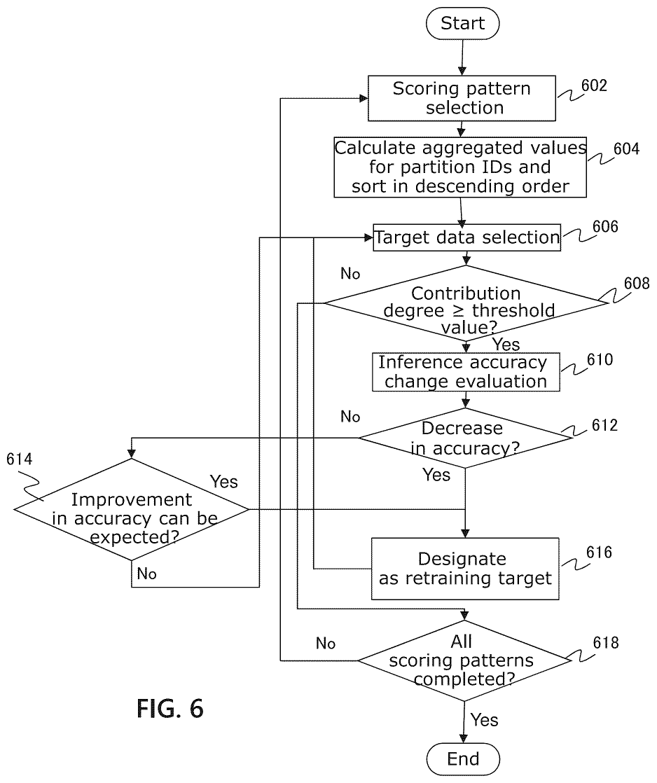

FIG. 6 is a flowchart showing processing performed by a data selection unit according to an embodiment of the present disclosure.

The data selection unit 186 selects a scoring pattern (step 602). The data selection unit 186 calculates the aggregated values for the partition IDs (see FIG. 4) and sorts the partition IDs in descending order of the aggregated values (step 604).

The data selection unit 186 selects target data (step 606). For example, the data selection unit 186 may select target data on the basis of the aggregated value, such as by selecting data with an aggregated value of 2 or more, or by similar methods.

The data selection unit 186 calculates the contribution degree and determines whether the contribution degree is equal to or larger than a predetermined threshold value (step 608). One example of a method for determining the threshold value of the contribution degree is to take into account the variance of the input data. For example, in the case where the characteristics of the input data are based on the standard deviation, the threshold value may be set to approximately 95% or more, which corresponds to 2σ. Alternatively, the threshold value may be determined on the basis of the accuracy target. For example, in the case where the accuracy of the top five data groups in terms of contribution degree exceeds the accuracy target required for the business operations, the threshold value may be set to include up to the 5th group. In the case where the contribution degree is equal to or larger than the threshold value determined on the basis of the input data, the processing proceeds to step 610. In the case where the contribution degree is less than the threshold value, the processing proceeds to step 618. Note that the contribution degree is a value indicating a specific group the data has contributed to the output of the result of the inference by the learning model belongs to.

In step 610, the data selection unit 186 evaluates the inference accuracy change.

In step 612, the data selection unit 186 determines whether there is a decrease in accuracy on the basis of the above-mentioned evaluation. If there is a decrease in accuracy, the processing proceeds to step 616. If there is no decrease in accuracy, the processing proceeds to step 614.

In step 614, the data selection unit 186 determines, on the basis of the above-mentioned evaluation of the accuracy change, whether an improvement in accuracy can be expected. Here, an improvement in accuracy based on the evaluation of the accuracy change refers to cases where the evaluation of frequently occurring input and output data in a certain time unit is incorrect, resulting in an accuracy change. At this point, as previously described, an improvement in accuracy can be expected by generating a correct answer provided by a person as retraining data and performing training. If an improvement in accuracy can be expected, the processing proceeds to step 616. If no improvement in accuracy can be expected, the processing returns to step 606.

In step 616, the data selection unit 186 designates the target data selected in step 606 as a retraining target. Then, the processing returns to step 606 to select the next target data.

In step 618, the data selection unit 186 determines whether processing has been completed for all scoring patterns. If completed, the processing shown in FIG. 6 ends. If not completed, the processing returns to step 602 to select the next scoring pattern.

As described above, the processor may calculate the contribution frequency and the accuracy change of each group according to two or more classification methods, and select the retraining target group using one selected classification method. Here, the classification method corresponds to the scoring pattern in FIG. 6. The contribution frequency corresponds to the contribution degree in FIG. 6. The accuracy change corresponds to the inference accuracy change in step 610.

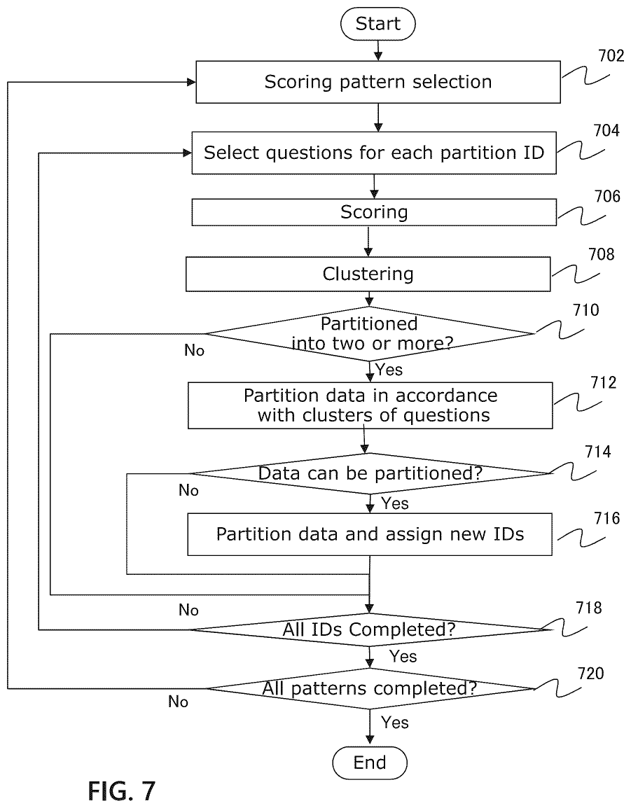

FIG. 7 is a flowchart showing processing performed by a data reclassification unit according to an embodiment of the present disclosure.

The data reclassification unit 190 selects a scoring pattern (step 702). The data reclassification unit 190 selects questions for each partition ID (step 704).

The data reclassification unit 190 performs scoring on the data on the basis of the selected scoring pattern (step 706). Next, the data reclassification unit 190 performs clustering (step 708).

The data reclassification unit 190 determines whether the data is partitioned into two or more groups as a result of the clustering (step 710). If it is determined that the data is partitioned into two or more groups, the processing proceeds to step 712. If it is determined that the data is not partitioned into two or more groups, the processing proceeds to step 718.

In step 712, the data reclassification unit 190 partitions the data in accordance with the clusters of the questions. If such partitioning is possible (step 714: Yes), the processing proceeds to step 716. If such partitioning is not possible (step 714: No), the processing proceeds to step 718.

In step 716, the data reclassification unit 190 partitions the data and assigns new IDs.

In step 718, the data reclassification unit 190 determines whether processing has been completed for all IDs. If completed, the processing proceeds to step 720. If not completed, the processing returns to step 704.

In step 720, the data reclassification unit 190 determines whether the processing has been completed for all scoring patterns. If completed, the processing shown in FIG. 7 ends. If not completed, the processing returns to step 702.

Note that the data reclassification unit 190 may reclassify data on the basis of the similarity of the questions. More specifically, the data reclassification unit 190 may calculate mutual similarity degrees between the inputs of the input and output data, and in the case where there are two or more input groups with a similarity degree equal to or larger than a predetermined value among the inputs of the input and output data associated with a classification, i.e., a group, partition the group into two or more groups for each of the input groups.

For example, in the case where a certain piece of data is associated with a plurality of question groups, the data group may be partitioned. In addition, if a plurality of pieces of data are associated with specific data, the data may be integrated. The vector distance of each piece of data may be used to determine the similarity of questions or data.

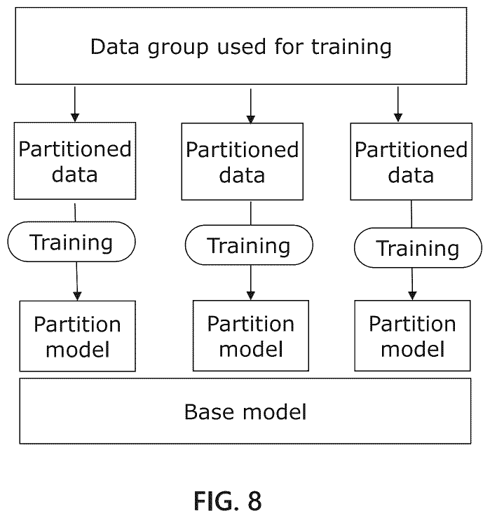

FIG. 8 is a conceptual diagram showing a configuration example of a learning model according to an embodiment of the present disclosure.

The learning model may include one base model related to all groups and a plurality of partition models each related to a respective one of the groups. The data group used for training is partitioned into a plurality of pieces of partitioned data. Then, each partition model is trained using its respective partitioned data.

The processor may retrain, on the basis of the retraining data, only the partition model related to the retraining target group.

If there is a group with a contribution frequency of zero, the processor may exclude the partition model related to the group from the learning model. In the case where there is data in the log data that is not associated with any question, the data and the partial LLM generated from the data may be excluded from the system or archived to a knowledge DB for low priority. This enables slimming down the data and the models.

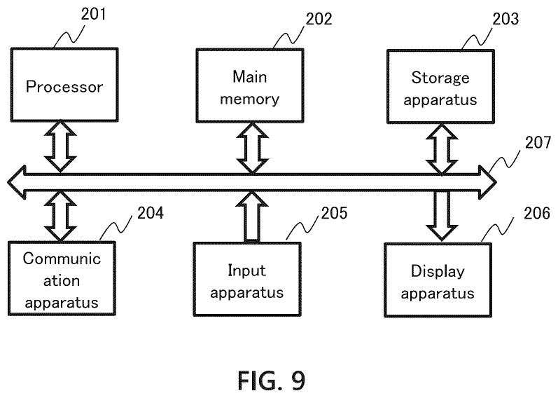

FIG. 9 is a block diagram showing an example of the hardware configuration of various apparatuses or systems according to an embodiment of the present disclosure.

The hardware configuration of the apparatus shown in FIG. 9 may correspond to any of the following: the data preparation apparatus 120, the training apparatus 140, the inference apparatus 160, the retraining apparatus 180, or the AI system 100. That is, each of these apparatuses may have hardware as shown in FIG. 9. In addition, two or more of these apparatuses may be integrated into one apparatus.

The apparatus shown in FIG. 9 includes a processor 201, a main memory 202, a storage apparatus 203, a communication apparatus 204, an input apparatus 205, a display apparatus 206, and a bus 207. The processor 201, the main memory 202, the storage apparatus 203, the communication apparatus 204, the input apparatus 205, and the display apparatus 206 are coupled to each other via the bus 207.

The processor 201 functionally implements various processing performed by the apparatuses by loading and executing programs and data stored in the main memory 202 or the storage apparatus 203. The main memory 202 and the storage apparatus 203 store programs and various data used by the apparatuses. The communication apparatus 204 has a function of performing communication with external apparatuses. The input apparatus 205 is composed of, for example, a keyboard, a mouse, a touch panel, or the like, and accepts user input. The display apparatus 206 is composed of, for example, a display, etc., and displays information to the user.

The processor may assign a weight to each of the partitioned data groups according to the contribution frequency of the group, and create, on the basis of the input and output data belonging to the retraining target group, retraining data with a data volume corresponding to the weight of the retraining target group. Such processing may be performed by the retraining apparatus 180, for example.

The ID may be stored in an external database provided outside the apparatus. The storage apparatus further stores an external database in which, for each of the groups, identification information for identifying the group is set. The processor, upon identifying a specific group the data has contributed to the output of the result of the inference belongs to, during the inference performed using the learning model and referring to the external database to identify identification information of the identified group, associates the identification information with the input and output data.

The identification information for identifying each of the groups may be configured such that the name of the identification information is a character string that does not appear in the input from the user, and the identification information itself may be represented by a special symbol that does not appear in the input from the user. The identification information here corresponds to the aforementioned ID.

It should be noted that the above-described embodiments of the present invention are examples for explaining the present invention, and are not intended to limit the scope of the present invention only to those embodiments. Those skilled in the art can implement the present invention in various other aspects without departing from the scope of the present invention. The embodiments of the present invention include items shown below. However, the items included in the embodiments of the present invention are not limited to those shown below.

### Item 1

As described above, in an apparatus for retraining a learning model and includes a storage apparatus and a processor, the storage apparatus is configured to store training data which is partitioned into two or more groups on the basis of a predetermined condition, and a learning model that has been trained using the training data; and
the processor is configured to:
upon performing inference using the learning model in response to an input, identify a specific group the data that has contributed to an output of a result of the inference by the learning model belongs to and associate the identified group with input and output data;
for each of the groups, calculate a contribution frequency, which is a frequency at which the data that belongs to the group has contributed to the output of the result of the inference by the learning model, and calculate an accuracy change, which indicates a change in the inference accuracy measured using test data created on the basis of the input and output data associated with the group, relative to the inference accuracy measured on the training data;
select a retraining target group from the groups on the basis of the contribution frequency and the accuracy change of each of the groups;
create retraining data on the basis of the input and output data belonging to the retraining target group according to the condition; and
retrain the learning model on the basis of the retraining data.

As a result, retraining is performed by using data belonging to groups that frequently contribute to the generation of an output by the learning model and for which an improvement in the inference accuracy through retraining is expected. Therefore, it is possible to perform retraining that efficiently improves the accuracy of the learning model.

### Item 2

In the apparatus described in Item 1, the processor is configured to, in the case where two or more input groups with different features exist within inputs of the input and output data associated with the group, partition the group into two or more groups according to each of the aforementioned features.

As a result, it becomes possible to further partition groups to reduce the data volume of the retraining data and improve the efficiency of the retraining.

### Item 3

In the apparatus described in Item 1, the processor is configured to calculate the contribution frequency and the accuracy change of each group according to two or more classification methods, and select the retraining target group using one selected classification method.

As a result, it becomes possible to achieve more suitable retraining by selecting and using an appropriate classification method from among a plurality of classification methods.

### Item 4

In the apparatus described in Item 1,
the learning model includes one base model related to all groups and a plurality of partition models each related to a respective one of the groups, and
the processor is configured to retrain, on the basis of the retraining data, only the partition model related to the retraining target group.

As a result, only the partition model of the retraining target group is retrained using the retraining data of the retraining target group, so that retraining can be performed efficiently.

### Item 5

In the apparatus described in Item 1,
the processor is configured to:
assign a weight to each of the groups according to the contribution frequency of the group, and
create, on the basis of the input and output data that belongs to the retraining target group, retraining data with a data volume corresponding to the weight of the retraining target group.

As a result, it becomes possible to create retraining data in consideration of the contribution frequencies of the groups, and to perform highly accurate retraining.

### Item 6

In the apparatus described in Item 2,
the processor is configured to calculate mutual similarity degrees between the inputs of the input and output data, and, in the case where there are two or more input groups with a similarity degree equal to or larger than a predetermined value among the inputs of the input and output data associated with the group, partition the group into two or more groups for each of the input groups.

As a result, it becomes possible to further partition groups according to the similarity degree to reduce the data volume of the retraining data and improve the efficiency of the retraining.

### Item 7

In the apparatus described in Item 4,
the processor is to configured to, when there is a group with a contribution frequency of zero, exclude a partition model related to the group from the learning model.

As a result, it becomes possible to reduce the size of the stored data and the learning model.

### Item 8

In the apparatus described in Item 1,
the processor is configured to:
add, to a user input provided by a user, an instruction to add identification information indicating a specific group the data that has contributed to the output of the result of the inference belongs to, to the output, and input the result to the learning model;
identify a specific group the data that has contributed to the output of the result of the inference belongs to, from the identification information output from the learning model; and
present, to the user, the user output obtained by removing the identification information from the output of the learning model.

As a result, it becomes possible to acquire the identification information of the groups without impairing user convenience.

### Item 9

In the apparatus described in Item 1,
the storage apparatus is configured to further store an external database in which, for each of the groups,
identification information for identifying the group is set; and
the processor is configured to: upon identifying a specific group the data that has contributed to the output of the result of the inference belongs to, during the inference performed using the learning model and referring to the external database to identify identification information of the identified group, associate the identification information with the input and output data.

As a result, it becomes possible for the learning model to accurately identify the identification information of the group that has contributed to the output of the result of the inference by having the identification information in the external database.

### Item 10

In the apparatus described in Item 1,
the identification information for identifying each of the groups is configured such that the name of the identification information is a character string that does not appear in the input from the user, and the identification information is represented by a special symbol that does not appear in the input from the user.

As a result, it becomes possible to avoid confusion between the identification information and the user input, and thus accurately identify the identification information in the output of the learning model.

### Item 11

In a retraining method for retraining a learning model by an apparatus that includes a storage apparatus and a processor, the method including:
by the storage apparatus, storing training data which is partitioned into two or more groups on the basis of a predetermined condition, and a learning model that has been trained using the training data; and
by the processor
upon performing inference using the learning model in response to an input, identifying a specific the group data that has contributed to an output of a result of the inference by the learning model belongs to and associate the identified group with input and output data;
for each of the groups, calculating a contribution frequency, which is a frequency at which data that belongs to the group has contributed to an output of a result of the inference by the learning model, and an accuracy change, which indicates a change in the inference accuracy measured using test data created on the basis of the input and output data associated with the group, relative to the inference accuracy measured on the training data;
selecting a retraining target group from the groups on the basis of the contribution frequency and the accuracy change of each of the groups;
creating retraining data on the basis of the input and output data belonging to the retraining target group according to the condition; and
retraining the learning model on the basis of the retraining data.

As a result, retraining is performed by using data belonging to groups that frequently contribute to the generation of an output by the learning model and for which an improvement in the inference accuracy through retraining is expected. Therefore, it is possible to perform retraining that efficiently improves the accuracy of the learning model.

### Item 12

A non-transitory computer-readable medium containing a retraining program for retraining a learning model, in an apparatus that includes a storage apparatus and a processor, the storage apparatus being configured to store training data which is partitioned into two or more groups on the basis of a predetermined condition, and a learning model that has been trained using the training data; and
the retraining program causing the processor to:
upon performing inference using the learning model in response to an input, identify a specific group the data has contributed to an output of a result of the inference by the learning model belongs to and associate the identified group with input and output data
for each of the groups, calculate a contribution frequency, which is a frequency at which data that belongs to the group has contributed to the output of the result of the inference by the learning model, and an accuracy change, which indicates a change in the inference accuracy measured using test data created on the basis of the input and output data associated with the group, relative to the inference accuracy measured on the training data;
select a retraining target group from the groups on the basis of the contribution frequency and the accuracy change of each of the groups;
create retraining data on the basis of input and output data belonging to the retraining target group according to the condition; and
retrain the learning model on the basis of the retraining data.

As a result, retraining is performed by using data belonging to groups that frequently contribute to the generation of an output by the learning model and for which an improvement in the inference accuracy through retraining is expected. Therefore, it is possible to perform retraining that efficiently improves the accuracy of the learning model.

What is claimed is:

1. A retraining apparatus for retraining a learning model, the retraining apparatus comprising:
a storage apparatus and a processor, wherein
the storage apparatus is configured to store training data which is partitioned into two or more groups on the basis of a predetermined condition, and a learning model that has been trained using the training data; and
the processor is configured to:
upon performing inference using the learning model in response to an input, identify a specific group the data has contributed to an output of a result of the inference by the learning model belongs to and associate the identified group with input and output data;
for each of the groups, calculate a contribution frequency, which is a frequency at which the data that belongs to the group has contributed to the output of the result of the inference by the learning model, and calculate an accuracy change, which indicates a change in the inference accuracy measured using test data created on the basis of the input and output data associated with the group, relative to the inference accuracy measured on the training data;
select a retraining target group from the groups on the basis of the contribution frequency and the accuracy change of each of the groups;
create retraining data on the basis of the input and output data belonging to the retraining target group according to the condition; and
retrain the learning model on the basis of the retraining data.

2. The retraining apparatus according to claim 1, wherein the processor is configured to, in the case where two or more input groups with different features exist within inputs of the input and output data associated with the group, partition the group into two or more groups for each of the features.

3. The retraining apparatus according to claim 1, wherein the processor is configured to
calculate the contribution frequency and the accuracy change of each group according to two or more classification methods, and
select the retraining target group using one selected classification method.

4. The retraining apparatus according to claim 1, wherein the learning model includes one base model related to all groups and a plurality of partition models each related to a respective one of the groups, and
the processor is configured to retrain, on the basis of the retraining data, only the partition model related to the retraining target group.

5. The retraining apparatus according to claim 1, wherein the processor is configured to
assign a weight to each of the groups according to the contribution frequency of the group, and
create, on the basis of the input and output data that belongs to the retraining target group, retraining data with a data volume corresponding to the weight of the retraining target group.

6. The retraining apparatus according to claim 2, wherein the processor is configured to calculate mutual similarity degrees between the inputs of the input and output data, and, in the case where there are two or more input groups with a similarity degree equal to or larger than a predetermined value among the inputs of the input and output data associated with the group, partition the group into two or more groups for each input group.

7. The retraining apparatus according to claim 4, wherein the processor is configured to, when there is a group with a contribution frequency of zero, exclude a partition model related to the group from the learning model.

8. The retraining apparatus according to claim 1, wherein the processor is configured to:
add, to a user input provided by a user, an instruction to add identification information indicating a specific group the data has contributed to the output of the result of the inference belongs to, to the output, and input the result to the learning model;
identify a specific group the data has contributed to the output of the result of the inference belongs to, from the identification information output from the learning model; and
present, to the user, the user output obtained by removing the identification information from the output of the learning model.

9. The retraining apparatus according to claim 1, wherein
the storage apparatus is configured to further store an external database in which, for each of the groups, identification information for identifying the group is set; and
the processor is configured to: upon identifying a specific group the data has contributed to the output of the result of the inference belongs to, during the inference performed using the learning model and referring to the external database to identify identification information of the identified group, associate the identification information with the input and output data.

10. The retraining apparatus according to claim 1, wherein the identification information for identifying each of the groups is configured such that the name of the identification information is a character string that does not appear in the input from the user, and the identification information is represented by a special symbol that does not appear in the input from the user.

11. A retraining method for retraining a learning model by an apparatus that includes a storage apparatus and a processor, the method comprising:
by the storage apparatus, storing training data which is partitioned into two or more groups on the basis of a predetermined condition, and a learning model that has been trained using the training data; and
by the processor
upon performing inference using the learning model in response to an input, identifying a specific the data has contributed to an output of a result of the inference by the learning model belongs to, and associating the identified group with input and output data;
for each of the groups, calculating a contribution frequency, which is a frequency at which data that belongs to the group has contributed to the output of the result of the inference by the learning model, and an accuracy change, which indicates a change in the inference accuracy measured using test data created on the basis of the input and output data associated with the group, relative to the inference accuracy measured on the training data;
selecting a retraining target group from the groups on the basis of the contribution frequency and the accuracy change of each of the groups;
creating retraining data on the basis of the input and output data belonging to the retraining target group according to the condition; and
retraining the learning model on the basis of the retraining data.

12. A non-transitory computer-readable medium containing a retraining program for retraining a learning model, in an apparatus that includes a storage apparatus and a processor,
the storage apparatus being configured to store training data which is partitioned into two or more groups on the basis of a predetermined condition, and a learning model that has been trained using the training data,
the retraining program causing the processor to:
upon performing inference using the learning model in response to an input, identify a specific group the data that has contributed to an output of a result of the inference by the learning model belongs to and associate the identified group with input and output data;
for each of the groups, calculate a contribution frequency, which is a frequency at which data that belongs to the group has contributed to the output of the result of the inference by the learning model, and an accuracy change, which indicates a change in the inference accuracy measured using test data created on the basis of the input and output data associated with the group, relative to the inference accuracy measured on the training data;
select a retraining target group from the groups on the basis of the contribution frequency and the accuracy change of each of the groups;
create retraining data on the basis of the input and output data belonging to the retraining target group according to the condition; and
retrain the learning model on the basis of the retraining data.
